(19) United States
(12) Patent Application Publication
(10) Pub. No.: US 2010/0254311 A1
(43) Pub. Date: Oct. 7, 2010

(54) Pulse-Coupled Discrete-Time Phase Locked Loops For Wireless Networks

(76) Inventors: Osvaldo Simeone, Hoboken, NJ (US); Umberto Spagnolini, Milano (IT); Yeheskel Bar-Ness, Marlboro, NJ (US)

Correspondence Address: GIBSON & DERNIER LLP, 900 ROUTE 9 NORTH, SUITE 504, WOODBRIDGE, NJ, 07095, US

(21) Appl. No.: 12/600,318

(22) PCT Filed: May 20, 2008
(86) PCT No.: PCT/US08/64220

§ 371 Date: May 28, 2010

Related U.S. Application Data
(60) Provisional application No. 60/940,186, filed on May 25, 2007.

(51) Int. Cl. H04W 40/00

(52) U.S. Cl. 370/328

(57) ABSTRACT

A model of a pulse-coupled discrete-time phase locked loops (PLLs) in a wireless network is provided. The PLLs at each node in the network may have an indeterminate order. A method for securing discrete-time distributed phase locked loops (PLLs) in a wireless network by including an outlier detection scheme in the timing update at each node is also provided. The method may include evaluating each collaborating node based on a weighted average of the clock errors and evaluating the dispersion of clock errors.

### TECHNICAL FIELD

The present invention relates to pulse-coupled discrete time phase locked loops for wireless networks.

### BACKGROUND ART

Mutual timing synchronization among nodes of a wireless networks enables an increasingly large number of applications in ad hoc and sensor networks, as discussed in F. Sivrikaya and B. F. Yener, “Time synchronization in sensor networks: a survey,” IEEE Network, vol. 18, no. 4, pp. 45-50, July-August 2004. Examples range from complex sensing tasks (distributed detection/estimation, data fusion) to medium access control for communication (e.g., Time Division Multiple Access). Recently, the traditional packet-based approach to mutual synchronization (i.e., nodes exchange packets with appropriate time-stamp) has been challenged by physical layer-based techniques, where local time information is exchanged among distributed clocks through transmission of pulses. Y.-W. Hong, A. Scaglione, “A scalable synchronization protocol for large scale sensor networks and its applications,” IEEE Journal Selected Areas Commun., vol. 23, no. 5, pp. 1085-1099. May 2005. The traditional packet-based approach to mutual synchronization is discussed in the F. Sivrikaya above, and in Qun Li and D. Rus, “Global clock synchronization in sensor networks,” IEEE Trans. Computers, vol. 55, no. 2, pp. 214-226, February 2006. The model of pulse-coupled oscillators used in the above mentioned literature is successful in explaining the mutual synchronization of (frequency-synchronous) clocks, but it appears to be hard to generalize and to relate to known results on traditional synchronization systems based on Phase Locked Loops (PLLs).

### SUMMARY OF THE INVENTION

An apparatus including a virtual wireless network that is modeled using pulse-coupled discrete-time phase locked loops (PLLs) is provided. The virtual wireless network may preferably be based on a known point-to-point PLL system. The apparatus may be configured to account for finite-time resolution of transmitted pulses, and/or for finite-time resolution of propagation delays. The apparatus may be configured and operable to illustrate the impact of a finite resolution parameter, a noise parameter, and/or an oversampling factor at the receiving side. A loop order of the apparatus may be arbitrary.

Methods and apparatus according to aspects of the invention may provide for modeling pulse-coupled discrete-time phase locked loops (PLLs) in a wireless network. Further aspects may include accounting for finite-time resolution of transmitted pulses, accounting for finite-time resolution propagation delays, illustrating the impact of a change to a finite-resolution parameter, illustrating the impact of a change to noise parameter, illustrating the impact of a change to an oversampling factor at the receiving side, said illustrating providing a basis for a selection of an oversampling factor that can maximize accuracy of synchronization in return for a reduction in complexity, and/or modeling the PLLs in a wireless network, said PLLs being in an arbitrary loop order.

Methods and apparatus according to aspects of the invention may provide for securing discrete-time distributed phase locked loops (PLLs) in a wireless network by including an outlier detection scheme in the timing update at each node, including: evaluating each collaborating node based on a weighted average of the clock errors; and evaluating the dispersion of clock errors. Further aspects may include considering as outliers all the clock differences that satisfy a predetermined formula, updating for only the set of clock differences that satisfies a predetermined formula, evaluating each collaborating node comprising evaluating independent of direct estimation of the times of arrival of received pulses at each node, leveraging a determination of an instantaneous energy measurement of a received signal via a center-of-mass detector.

Methods and apparatus according to aspects of the invention may provide for a model of a pulse-coupled discrete-time phase locked loops (PLLs) in a wireless network, the PLLs at each node in the network having an indeterminate order. The model may include that the number of poles at each node are indeterminate, transmitting pulses in every period by switching between transmission and reception mode after pulse transmission, and/or allowing nodes to select independently whether to receive or transmit in order to improve the resolution of synchronization.

### BRIEF DESCRIPTION OF THE DRAWING

The objects and advantages of the invention will be apparent upon consideration of the following detailed description, taken in conjunction with the accompanying drawings, in which like reference characters refer to like parts throughout, and in which:

FIG. 1 is (a) a network of discrete-time clocks connected through a wireless channel and (b) an Illustration of the signal transmitted by the i^{th} node;

FIG. 2 is a sketch of the received signal in the observation window around the firing instant, tᵢ(n) (W measures the refractory time due to half-duplex constraint);

FIG. 3 is an equivalent block diagram of a discrete-time PLL with an infinite-resolution time error detector, where the delays qᵢⱼ have been incorporated in the effective local frequencies 1/Tᵢ^{(Q)};

FIG. 4 shows Eigenvalues of the second order loop system (6) of matrix 11, in the case of two users with μ increasing from 0 to 1 (epsilon=0.9);

FIG. 5 shows the standard deviation of the clocks {tᵢ(n)}I=1 to N versus a period index n: infinite resolution, where the dashed lines correspond to the analytical result (9);

FIG. 6 shows the standard deviation of the clocks {tᵢ(n)}I=1 to N versus a period index n: finite resolution;

FIG. 7 shows the standard deviation vₜ(n) of the clocks of the collaborating nodes versus n for certain approaches discussed herein (K=20, Km=4), and a reference of performance with no malicious nodes (Km=0); and

FIG. 8 shows the standard deviation vₜ(n) of the clocks of the collaborating nodes versus the fraction of malicious nodes Km/K for certain approaches discussed herein (K=20 N=100 iterations).

### BEST MODE OF CARRYING OUT THE INVENTION

The goal of this work is to reconsider the problem of mutual clock synchronization through pulse-coupled oscillators by using conventional (discrete-time) linear PLLs. The model can be seen as the discrete-time counterpart of the system of continuously-coupled analog (linearized) PLLs. This system is discussed in W. C. Lindsey, F. Ghazvinian, W. C. Hagmann and K. Desseouky, “Network synchronization,” Proc. of the IEEE, vol. 73, no. 10, pp. 1445-1467, October 1985.

First-order PLLs for mutual time (phase) synchronization in the presence of frequency-synchronous clocks have been considered in Qun Li and D. Rus (discussed above) and in F. Tong and Y. Akaiwa, “Theoretical analysis of interbase-station synchronization systems,” IEEE Trans. Commun., vol. 46, no. 5, pp. 590-594, 1998, and E. Sourour and M. Nakagawa, “Mutual decentralized synchronization for intervehicle communications.” IEEE Trans. Veh. Technol., vol. 48, no. 6, pp. 2015-2027, November 1999. In Qun Li and D. Rus, a convergence proof is provided by leveraging tools from algebraic graph theory. In all of these works, with the exception of E. Sourour and M. Nakagawa, none deal with finite-resolution of pulses. Indeed, in Qun Li and D. Rus packet-based synchronization is assumed. Finally, the framework of distributed PLLs has strong connections with the literature on consensus of multi-agent networks, as disclosed as an overview in Wei Ren, R. W. Beard and E. M. Atkins, “A survey of consensus problems in multi-agent coordination,” in Proc. American Control Conference, vol. 3, pp. 1859-1864. June 2005, and in the context of distributed estimation in G. Scutari, S. Barbarossa and L. Pescosolido, “Optimal decentralized estimation through self-synchronizing networks in the presence of propagation delays,” in Proc. SPAWC 2006. In fact, a special case of the system considered here (first-order PLLs with frequency-synchronous clocks) coincides with the conventional discrete-time consensus model discussed in Wei Ren, R. W. Beard and E. M. Atkins, and a (non-linear) continuous-time model similar to the one studied here is investigated in G. Scutari, S. Barbarossa and L. Pescosolido as a means to achieve global distributed estimation.

The technical aspects involved in the present invention include:

1. A model of pulse-coupled discrete-time PLLs with arbitrary loop order is introduced for achieving synchronization over decentralized wireless networks, such as ad hoc or sensor networks. The model preferably accounts for finite time-resolution of transmitted pulses and propagation delays.

2. An analysis of steady-state and convergence properties of the system of second-order PLLs under the ideal assumption of infinite-resolution time error detectors is provided. Results exploit tools from algebraic graph theory, similarly to Wei Ren, R. W. Beard and E. M. Atkins, and show that conclusions well known in the context of conventional point-to-point PLLs extend naturally to a distributed system. Thus, the design of the distributed system of PLLs for phase and frequency synchronization may follow known art from point-to-point PLLs.

3. The analysis is corroborated with numerical results and further illustrate the impact of finite-resolution, noise and system parameters such as oversampling factors at the receiving side.

4. The phase detector at each node of the network preferably works without direct estimation of the times of arrival of the received pulses. Instead, instantaneous energy measurements of received signal, after sampling, are leveraged via a center-of-mass detector. In certain embodiments, an oversampling factor in the sampling process can be selected in order to trade complexity for accuracy of synchronization.

5. The PLLs at each node may have any given order (e.g., any number of poles).

6. The inclusion of an outlier detection scheme in the timing update at each node allows to achieve resilience to malicious or malfunctioning nodes.

7. Two schedules are possible for pulse transmission. Pulses can be transmitted by each node in every period by switching between transmission and reception mode (and vice versa) after (and before) pulse transmission. Alternatively, a random schedule can be employed where nodes select independently whether to receive or transmit in any period in order to improve the resolution of synchronization.

### Pulse-Coupled Synchronization

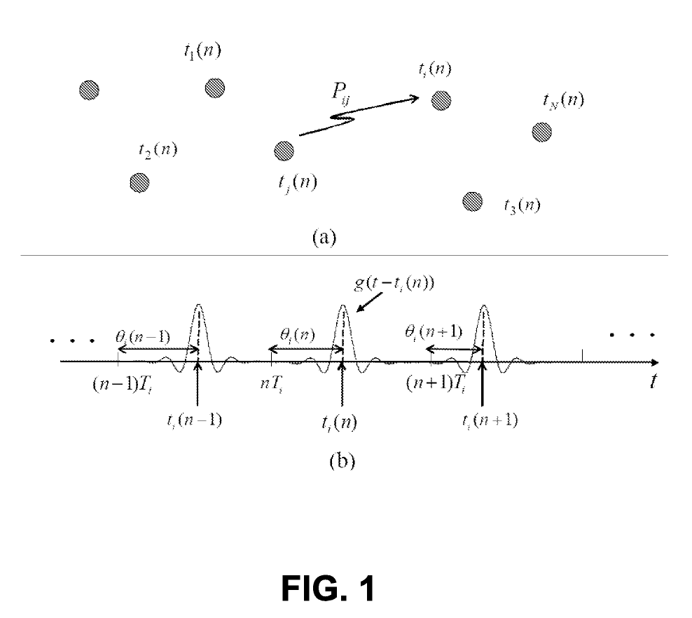

FIG. 1 shows a network of N clocks with different free-oscillation frequencies {1/Tᵢ}ᵢ₌₁^{N} arising from random frequency offsets around a nominal value. Nodes communicate over a wireless channel and the topology of the network determines the power Pᵢⱼ received by any ith node from the jth as Pᵢⱼ=Cᵢⱼ/dᵢⱼ^{γ}, where Cᵢⱼ is an appropriate constant (accounting for possible fading and shadowing), dᵢⱼ=dⱼᵢ is the distance between the nodes and γ is the path loss exponent (γ=2÷4).

The ith clock is defined by a discrete-time function tᵢ(n), that, in case of isolated (or uncoupled) nodes, evolves as tᵢ(n)=nTᵢ+θᵢ(0), where index n=1, 2, . . . runs over the periods of the clock and 0≦θᵢ(0)<Tᵢ is an arbitrary initial phase. Notice that, in order to simplify the analysis, phase noise and frequency drifts are neglected. Two synchronization conditions are of interest. It is stated herein that the N clocks are frequency synchronized to a common frequency 1/T if tᵢ(n+1)−tᵢ(n)=T for each i and for sufficiently large n. A more strict condition requires full frequency and phase synchronization, i.e., t₁(n)=Λ=t_{N}(n) for n sufficiently large.

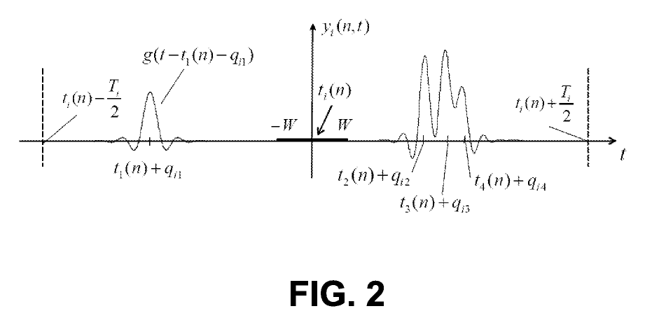

Towards the goal of achieving synchronization, clocks are coupled through the transmission by each node, say the ith, of a waveform g(t) at each tick of the local clock tᵢ(n), or some other predetermined time period, either in a given dedicated bandwidth or spread spectrum code or in an overlay system such as UWB (see lower part of FIG. 1). Nodes are assumed to be half-duplex, which implies that, when transmitting, they are not able to receive. Assuming that g(t) is a time-limited pulse, such as a truncated Nyquist waveform, any ith node can then switch from transmit to receive mode (or viceversa) right after (or before) transmission of a pulse at times tᵢ(n). If W_{g}∝1/B represents the duration of pulse g(t) (with bandwidth B) and Wₛ is the switching time between transmit and receive modes, the sum 2W=2Wₛ+W_{g} represents the refractory time around tᵢ(n) when the ith node cannot receive (see FIG. 2). When receiving, nodes process the combination of pulses received from other nodes with the aim of reaching a synchronized state, as explained below. Notice that, from this discussion, time 2W sets a lower bound on the resolution of the synchronization process. (A way to overcome this limitation could be to use (possibly random) pulse transmission scheduling among the clocks so as to enable the nodes to observe the synchronization signal from other nodes (FIG. 2) without refractory times in given periods.)

In Y.-W. Hong, A. Scaglione a pulse detector is run at each node on the received signal with the goal of updating the local clock according to the integrate-and-fire mechanism introduced in R. E. Mirollo and S. H. Strogatz, “Synchronization of pulse-coupled biological oscillators” SIAM Journal on Applied Mathematics, vol. 50, no. 6, pp. 1645-1662, December 1990. An alternative approach is described herein, extending the state of the art regarding first-order PLLs for mutual time (phase) synchronization in the presence of frequency-synchronous clocks. This alternative approach is based on the familiar mechanism of discrete-time PLLs, that will be shown to have desirable properties in terms of flexible design and relative ease of analysis.

Basic Mechanism with Ideal Time Difference Detectors In order to explain the basic idea, let it be assumed that each node, say the ith, is able at each period n to estimate the difference between its own clock tᵢ(n) and that of other nodes tⱼ(n) (j≠i) from the received signal sketched in FIG. 2, up to the inevitable propagation and processing delay. More precisely, defining as qᵢⱼ the delay between transmission of pulse g(t−tⱼ(n)) by node j and processing of the latter at node i (by symmetry, qᵢⱼ=qⱼᵢ), node i measures the “delayed” time difference tⱼ(n)+qᵢⱼ−tᵢ(n). What is being neglected at this stage is the finite time-resolution of the transmitted waveform g(t), the refractory time 2W and noise at the receiver side. These issues are described in more detail below in the section entitled Finite-Resolution Time Error Detectors. However, similarly to Wei Ren, R. W. Beard and E. M. Atkins, a fully meshed network where nodes know the time differences with respect to all other nodes is not assumed. On the contrary, such measurements are possible only between “neighboring” nodes, as detailed below.

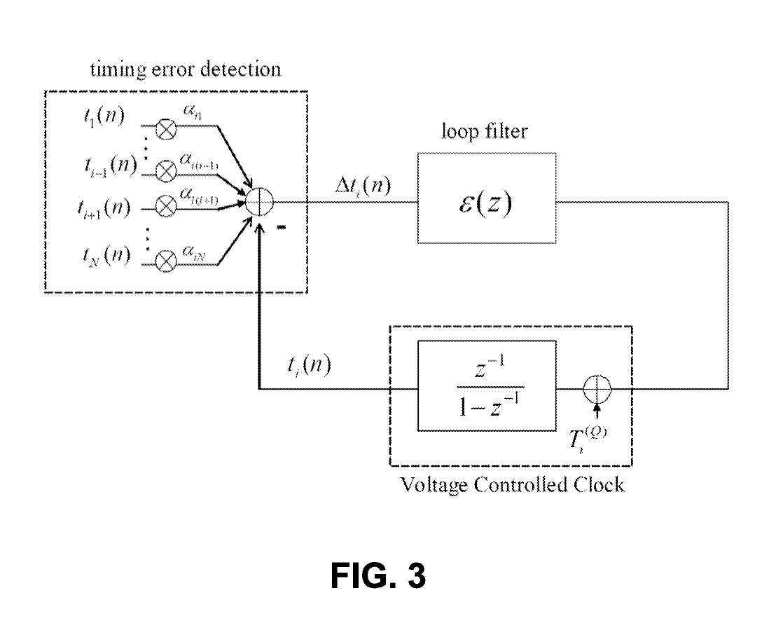

Based on the time-difference measurements, the ith clock updates its instantaneous phase θᵢ(n) in tᵢ(n)=nTᵢ+θᵢ(n) (see FIG. 1). This operation is performed according to a discrete-time PLL (see FIG. 3). In particular, a timing error detector estimates a convex combination of the “delayed” time differences tⱼ(n)+qᵢⱼ−tᵢ(n) for j≠i, at the nth period. This resembles the operation performed by the phase detector in the system of distributed analog PLLs of W. C. Lindsey (discussed above). Defining as αᵢⱼ≧0 and Σ_{j=1, j≠k}^{K}αᵢⱼ=1 for the convex combination weights, the outputs of the time error detector reads Δtᵢ^{(Q)}(n+1)=Δtᵢ(n+1)+Qᵢ, where the convex combination of (non-delayed) time differences is defined as

$$Δ {t}_{i} ( n + 1 ) = {\sum }_{j = 1 , j \neq i}^{N} {α}_{ij} ( {t}_{j} ( n ) - {t}_{i} ( n ) ) \qquad ( 1 )$$

and Qᵢ=Σ_{j=1, j≠i}^{N}αᵢⱼqᵢⱼ. The measure Δtᵢ^{(Q)}(n+1) is fed to a loop filter ε(z)=ε₀/(1−μz⁻¹), where 0<ε₀<1 denotes the loop gain and 0≦μ<1 the loop pole. As it is customary in the literature on PLLs, the scope is limited to first (μ=0) and second (μ≠0)-order PLLs. The output of filter ε(z) drives the local Voltage Control Clock (VCC) as

$$\begin{matrix}\begin{matrix}{t}_{i} ( n + 1 ) - {t}_{i} ( n ) = {ɛ}_{0} Δ {t}_{i}^{( Q )} ( n + 1 ) + μ ( {t}_{i} ( n ) - {t}_{i} ( n - 1 ) ) + \\ ( 1 - μ ) {T}_{i}\end{matrix} & ( 2 A ) \\ \begin{matrix}= {ɛ}_{0} Δ {t}_{i} ( n + 1 ) + μ ( {t}_{i} ( n ) - {t}_{i} ( n - 1 ) ) + \\ ( 1 - μ ) {T}_{i}^{( Q )} .\end{matrix} & ( 2 B )\end{matrix}$$

where Tᵢ^{(Q)}=T_{i+ε}₀Qᵢ/(1−μ).

Equation (2A and 2B) defines the dynamics of the set of pulse-coupled discrete-time PLLs over a connectivity graph defined by weights αᵢⱼ under the idealistic assumptions of infinite-resolution time error detectors. Notice that the impact of delays has been incorporated in the definition of “effective” free-oscillation periods Tᵢ^{(Q)}, so that the PLLs can be described equivalently as in FIG. 3. It is concluded that delays have the same effect as frequency offsets of the local clocks. Moreover, differently from packet-based schemes, the delays qᵢⱼ (and thus Qᵢ) preferably do not depend on the random queuing and processing delays due to creation of packets and medium access control, while depending solely on propagation and processing times at the baseband level. Finally, in order to compensate for delays, each node only needs an estimate of the aggregate measure Qᵢ, which, in the case of a large number of nodes, may be obtained from ensemble statistics of the network topology.

Convergence analysis of the set of pulse-coupled PLLs (2A and 2B) (with infinite-resolution time error detectors) is studied in the section below entitled System Analysis, borrowing some graph algebraic tools from the analysis of consensus algorithms, e.g., of Wei Ren.

### Finite-Resolution Time Error Detectors

In the discussion above, it was assumed that any ith node is able to measure the time differences with respect to neighboring nodes (i.e., nodes j such that αᵢⱼ>0) so as to calculate the (delayed) time error Δtᵢ^{(Q)}(n). Here this assumption is removed by considering the finite resolution of the transmitted waveform g (t), the refractory time 2W due to half-duplex constraint and switching time, and the noise at the receiving side. For the sake of illustration, a specific scheme is presented but variants are possible as well. Any ith node, at the nth period, observes the received signal yᵢ(n,t) over a time window of size equal to the local period Tᵢ around the firing instant tᵢ(n), with the exception of the time interval of duration 2W around tᵢ(n) because of the half-duplex constraint (see FIG. 2 for a sketch with arbitrary waveforms and no noise). The transmitted pulse g(t) is a truncated square-root Nyquist waveform with roll-off δ, such that the autocorrelation r_{g}(t) has peak-to-first zero time Wₚ=(1δ)/(2B) (a reasonable figure is W_{g}=6Wₚ). The ith node performs baseband filtering matched to the transmitted waveform g(t), and then samples the received signal at some multiple L of the symbol frequency 1/Wₚ, i.e., L/Wₚ with L≧1. This operation produces the samples yᵢ(n, m) in the nth observation window, where m∈J={(−0.5LTᵢ/Wₚ, . . . , −└LW/Wₚ┘)∪(└LW/Wₚ┘, . . . , 0.5LTᵢ/Wₚ]}, the sample m=0 corresponding to the “firing” instant tᵢ(n) (recall FIG. 2):

$${y}_{i} ( n , m ) = {\sum }_{j = 1 , j \neq i}^{N} \sqrt{{E}_{ij}} \cdot {r}_{g} ( \frac{{mW}_{p}}{L} - ( {t}_{j} ( n ) + {q}_{ij} - {t}_{i} ( n ) ) ) + w ( n , m ) . \qquad ( 3 )$$

In (3), the waveform r_{g} is the autocorrelation of g(t), the average energy per symbol reads Eᵢⱼ=PᵢⱼW_{g} (assuming r_{g}(0)=1), and w(n, m) is the additive Gaussian noise with zero mean and power N₀.

Based on the samples yᵢ(n, m), the time error detector at ith node needs to estimate the quantity Δtᵢ^{(Q)}(n)=Σ_{j=1, j≠i}^{N}αᵢⱼ(tⱼ(n)+qᵢⱼ−tᵢ(n)). An effective time detector is proposed that does not need to explicitly estimate the arrival times tⱼ(n)+qᵢⱼ(j≠i). To illustrate the idea, consider the specific choice for the convex weights αᵢⱼ

$${α}_{ij} = \frac{{P}_{ij}}{{\sum }_{j = 1 , j \neq i}^{N} {P}_{ij}} , \qquad ( 4 )$$

(as proposed in F. Tong and Y. Akaiwa; and E. Sourour and M. Nakagawa) for first-order discrete-time PLLs. According to (4), the ideal time error detector evaluates the weighted average of the time differences tⱼ(n)+qᵢⱼ−tᵢ(n) based on the fraction of power received on the corresponding pulse. A possible estimate of Δtᵢ^{(Q)}(n) can then be obtained as the following “center-of-mass” timing detector:

$$\begin{matrix}{Δ {t}_{i}^{( Q )}}^{⋒} ( n ) = {\sum }_{j ∈ J} {{α}^{̑}}_{ij} \cdot \frac{j {W}_{p}}{L} & 5 A \\ {{α}^{̑}}_{ij} = \frac{{\vert {y}_{i} ( n , j ) \vert}^{2}}{{\sum }_{k ∈ J} {\vert {y}_{i} ( n , k ) \vert}^{2}} . & 5 B\end{matrix}$$

With the simple implementation of the time error detector described in (5A and 5B), all the received samples are weighted by the instantaneous received power in order to evaluate the “center of mass” of the received signal in order to drive the voltage controlled clock (2A). Possible variants include the introduction of a threshold on the received power in order to include only a subset of significant times in the sum (4) (see, for example E. Sourour and M. Nakagawa). The performance of this scheme will be investigated in the section below entitled Numerical Results.

### System Analysis

In this section, the convergence properties of the system of pulse-coupled PLLs is analyzed under the idealistic assumption of infinite resolution time error detector. Under this condition, equation (2B) holds and the dynamics of the system can be easily shown to be described by the first-order vector difference equation

t(n+1)=(A+μI)·t(n)−μt(n−1)+(1−μ)T, (6)

where the vectors are defined as t(n)=[t₁(n)Λt_{N}(n)]^{T} and T=[T₁^{(Q)}ΛT_{N}^{(Q)}]^{T}. Moreover, the system matrix reads A=I−ε₀L, with L being the graph Laplacian of the network: [L]ᵢᵢ=Σ_{j≠i}αᵢⱼ=1 (i.e., the degree of node i) and [L]ᵢⱼ=−αᵢⱼ for i≠j. Notice that matrix A is stochastic: A·1=1. Model (6) coincides with the framework considered in the literature on consensus of multi-agent networks for the special case μ=0 and T=0 (see for example, Wei Ren, R. W. Beard and E. M. Atkins). In other words, the consensus model describes a scenario with first-order PLLs (μ=0) and frequency synchronous clocks (T=0). Therefore, from the results surveyed in Wei Ren, R. W. Beard and E. M. Atkins, it can be concluded that, with μ=0 and frequency synchronous clocks, if the connectivity graph of the network is strongly connected (or equivalently matrix A is irreducible), system (6) achieves full synchronization (with an exponential rate).

The general case of μ>0 and frequency asynchronous clocks (i.e., Tᵢ≠Tⱼ for i≠j) is now considered. A possible value for the synchronized frequency is denoted as 1/T (to be determined), i.e., tᵢ(n)−tᵢ(n−1)=T for sufficiently large n, so that the clock of the ith node can be written (for large n) as

tᵢ(n)=nT+τᵢ(n), (7)

where τᵢ(n) denotes the relative phase with respect to the common frequency. In vector form, the previous equation becomes t(n)=nT·1+τ(n) with τ(n)=[τ₁(n)Λτ_{N}(n)]^{T}. The equilibrium point (steady state) of the system (6) is identified by the following proposition.

Proposition 1: If the network of distributed PLL is strictly connected, the equilibrium point of system (6) is characterized by solutions t(n)=nT·1+τ*, where the common period reads

T=v^{T}T, (8)

with v being the normalized left eigenvector of matrix A corresponding to eigenvalue 1(A^{T}v=v with 1^{T}v=1), and the steady-state phase vector τ* is

$${τ}^{*} = 1 \cdot η + ( 1 - μ ) \frac{{L}^{†}}{ɛ} Δ T , \qquad ( 9 )$$

with (·)^{†} denoting the pseudoinverse, and with definitions

$$η = {v}^{T} ( τ ( 0 ) - ( 1 - μ ) \frac{{L}^{†}}{ɛ} Δ T ) {and [ Δ T ]}_{k} = {T}_{k} - T . \qquad ( 10 )$$

The system (6) can be written in terms of phases τ(n) relative to the common period T as

τ(n+1)−τ(n)=−ε₀Lτ(n)+μ(τ(n)−τ(n−1))+(1−μ)ΔT. (16)

An equilibrium state τ* for the difference equation (16) satisfies τ(n+1)=τ(n)=τ(n−1)=τ*, which yields the condition

$$L {τ}^{*} = ( 1 - μ ) \frac{Δ T}{{ɛ}_{0}} . \qquad ( 17 )$$

From (17), it follows that: (i) in order for (17) to be feasible (i.e., for an equilibrium point to exist), the common clock period T must satisfy v^{T}ΔT=0 or equivalently (8); (ii) an equilibrium phase vector τ* must read τ*=(1−μ) L^{†}/εΔT+η1 where η is an arbitrary constant.

The following definition is implemented

$${τ}^{′} ( n ) = τ ( n ) - ( 1 - μ ) \frac{{L}^{†} Δ T}{ɛ} .$$

With this change of variables, the difference equation (16) boils down to

τ′(n+1)=A·τ′(n)+μ(τ′(n)−τ′(n−1)). (18)

The system (18) is a second-order vector difference equation, that can be studied by recasting it as a first-order vector difference equation in terms of vector \tilde{τ}(n)=[τ′(n)^{T}τ′(n−1)^{T}]^{T} with system matrix Ã (11). Convergence of the corresponding system \tilde{τ}(n)=Ã\tilde{τ}(n−1) depends on the eigenvalues of Ã. It is easy to see that Ã has an eigenvalue equal to one, with left and (normalized) right eigenvectors z_{λ}=1 and zᵣ=1/(1−μ)·[v^{T}−μv^{T}]^{T} (recallthat v is the right eigenvector of A corresponding to the eigenvalue λ=1). Moreover, it can be shown that this eigenvalue is unique 10. Therefore, the system (18) is stable if and only if all the remaining 2K−1 eigenvalues of Ã have absolute value less than one (see, e.g., Wei Ren, R. W. Beard and E. M. Atkins). Assuming that the stability condition mentioned above holds, then Ãⁿ→z_{λ}zᵣ^{T} for n→∞(see, e.g., Wei Ren, R. W. Beard and E. M. Atkins) and the phases τ′(n) converge as τ′(n)→1v^{T}τ′(0) (having set τ(−1)=τ(0)), which implies that the constant η in (9) is (10).

Proposition 1 is the counterpart of known facts in the analysis of conventional PLLs, wherein first and second order loops lead to a static phase error that is proportional to the frequency mismatch similarly to (9) (see F. M. Gardner, Phaselock Techniques, John Wiley & Sons, Inc., 1966). It can be seen that introducing a pole, μ in the loop causes a reduction in the steady state phase error by a factor 1=μ.

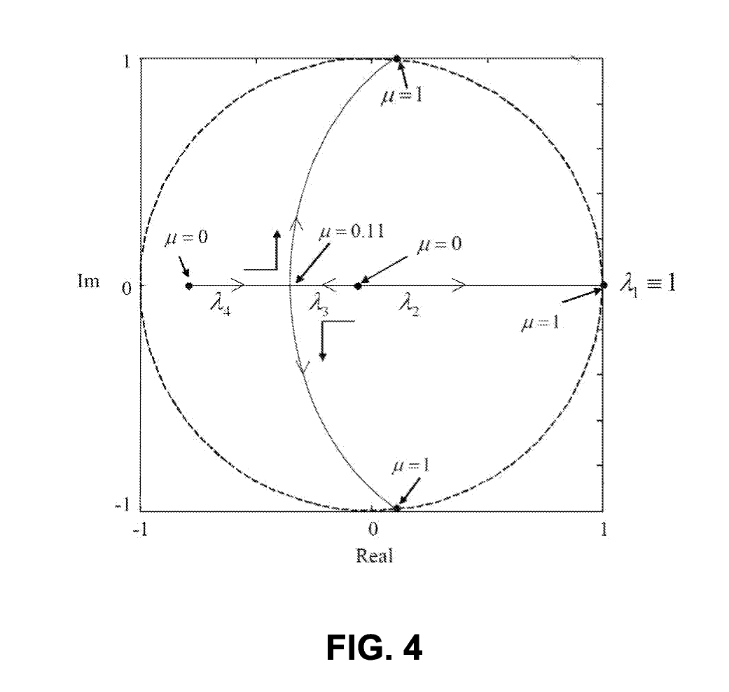

However, it remains to be proved that the system of distributed PLLs actually converges to the steady-state illustrated by Proposition 1. It is pretty straightforward, by using the results surveyed in Wei Ren, R. W. Beard and E. M. Atkins, to prove that convergence is guaranteed for any 0<ε₀<1 if μ=0 (first-order PLLs). However, the same is not true for second-order PLLs (0<μ<1). Referring to 10 for further analysis on this point, here this issue is illustrated by means of an example. Consider a network with two nodes. In this case, α₁₂=α₂₁=1 and the graph is connected. FIG. 4 shows the four eigenvalues of the system matrix associated with (6)

$$\tilde{A} = [ \begin{matrix}A + μ I & - μ I \\ I & 0\end{matrix} ] , \qquad ( 11 )$$

for different values of the pole μ and ε₀=0.9. Notice that the system matrix (11) is 4×4 since (6) is a system of two second order difference equations. Moreover, one eigenvalue of Ã is 1 irrespective of the value of μ. The absolute value of the remaining eigenvalues tends to one for μ→1, showing that increasing the value of the pole in the loop filter ε(z) leads to lack of stability of the equilibrium point (9). It can be concluded that, as in the case of conventional PLLs (e.g., as described in F. M. Gardner), the static phase error reduction achieved with the introduction of a pole μ comes at the expense of decreased margins of stability.

### Numerical Results

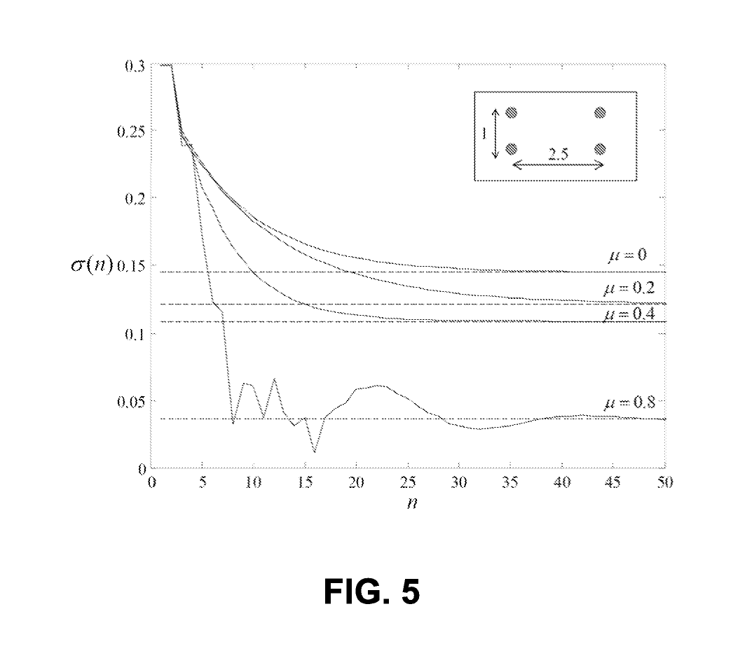

In this section, the analysis of infinite-resolution PLLs carried out in the previous section is corroborated, and then this ideal performance is compared with the case of finite resolution studied in the section entitled Finite-resolution time error detectors. Consider the choice (4) for the weighting coefficients αᵢⱼ, and a simple geometry with K=4 nodes located on the vertices of a rectangle with side ratio 1:2.5 (see box in FIG. 5). Moreover, the following may be set Cᵢⱼ=C so that the coefficients αᵢⱼ (4) only depend on relative distances. FIG. 5 shows the standard deviation σ(n) of the timing vector t(n) versus n, where σ²(n)=¼·Σₖ₌₁⁴(tₖ(n)−¼Σₖ₌₁⁴tₖ(n))², for T=1, ΔT=[−0.02 −0.01 0.01 0.02]^{T} and initial phases θ(0)=τ(0)=[0.1 0.4 0.6 0.8]^{T}. Other parameters are selected as γ=3 and ε₀=0.6. Different values of the pole, μ are considered showing: (i) a reduction in steady state synchronization error with increasing, μ (dashed lines correspond to the analytical result (9)); (ii) the occurrence of an oscillating behavior for increasing μ that leads to lack of convergence for μ→1 not shown for clarity).

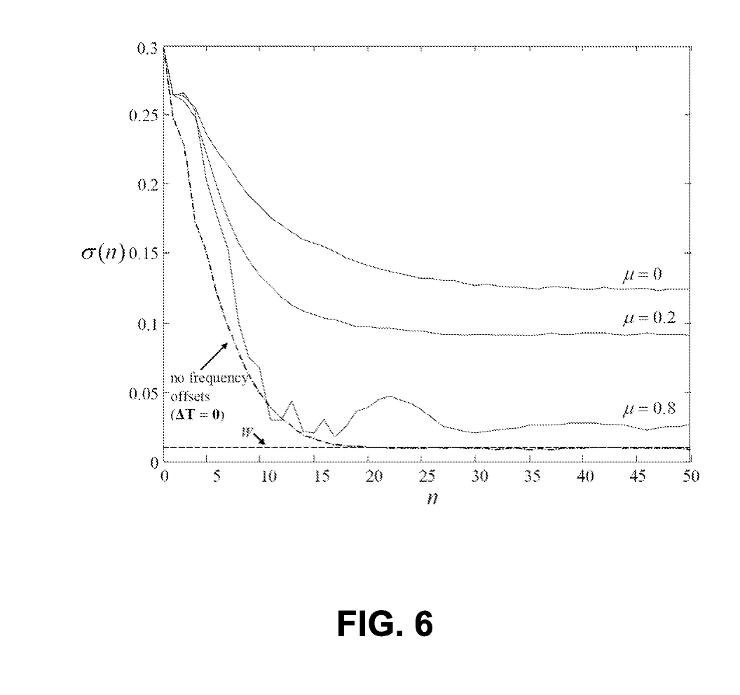

FIG. 6 revisits the previous examples by considering finite resolution, as described in the section entitled Finite-resolution time error detectors. Roll-off of the waveform g(t) is δ=0.2, the signal to noise ratio reads P̅/N₀=25 dB where P̅ is the power received along the short sides of the rectangular topology. FIG. 6 shows the standard deviation σ(n) averaged over noise through Monte Carlo simulations. The normalized timing resolution is Wₚ=0.01, the switching time is set to W=Wₚ for simplicity and the oversampling factor to L=2. It is seen that the same qualitative behavior of FIG. 5 is reproduced by increasing the pole, μ even in the case of a practical timing error detector. As a reference, the case with no frequency mismatch ΔT=0 is considered. It can be seen that in this case the error floor is set by the half duplex constraint W=0.01.

### A Secure Algorithm for Distributed Discrete-Time PLLs

Yet another embodiment of this invention is related to a solution to the issue of attack resilience (or fault tolerance, in case of malfunctioning nodes) of a synchronization scheme according to the invention.

In this section, a solution to the issue of attack resilience of a synchronization scheme according to the invention is described. The basic scheme prescribes the evaluation by each collaborating node in K_{c}, say the k th, of the weighted average Δtₖ(n) of the clock errors {δtₖᵢ(n)}_{i=1, i≠k}^{K} in {δtₖᵢ(n)}_{i≠k}

$$Δ {t}_{k} ( n ) = {\sum }_{i = 1 , i \neq k}^{K} {α}_{ki} \cdot δ {t}_{ki} ( n ) , \qquad ( 12 )$$

Using only this measure, it is not possible for the nodes to recognize possible suspicious outliers that attempt to disrupt the synchronization process. Toward this goal, a possible solution is to evaluate the dispersion of the clock errors {δtₖᵢ(n)}_{i=1, i≠k}^{K} around the mean Δtₖ(n), by, e.g., computing the variance

$${σ}_{k}^{2} ( n ) = {\sum }_{i = 1 , i \neq k}^{K} {α}_{ki} \cdot {( δ {t}_{ki} ( n ) - Δ {t}_{k} ( n ) )}^{2} , \qquad ( 13 )$$

and then consider as outliers all the clock differences δtₖᵢ(n) that satisfy

|δtₖᵢ(n)−Δtₖ(n)|>βσₖ(n), (14)

where β is some constant. The update of the scheme according to the invention is performed by considering only the set of clock differences such {δtₖᵢ(n)}_{i=1, i≠k}^{K} such that index i belongs to the set Iₖ(n)={i≠k:|δtₖᵢ(n)−Δtₖ(n)|≦βσₖ(n)}. In other words, the scheme is modified by substituting Δtₖ(n) with

$$\begin{matrix}{\overline{Δ t}}_{k} ( n ) = {\sum }_{i ∈ {I}_{k} ( n + 1 )} {\tilde{α}}_{ki} \cdot δ {t}_{ki} ( n ) & 15 A \\ {\tilde{α}}_{ki} = \frac{{α}_{ki}}{{\sum }_{j ∈ {I}_{k} ( n + 1 )} {α}_{ki}} . & 15 B\end{matrix}$$

Notice that normalization of the coefficients \tilde{α}ₖᵢ in (15B) is needed to guarantee that (15A) is a convex combination, i.e., Σ_{i∈I}_{ₖ}(n+1)\tilde{α}ₖᵢ=1.

### Numerical Results for the Secure Algorithm

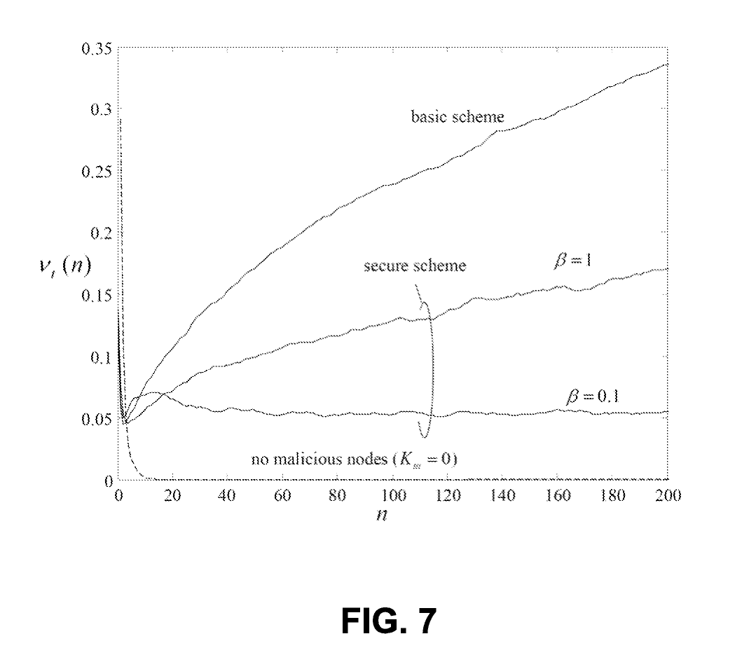

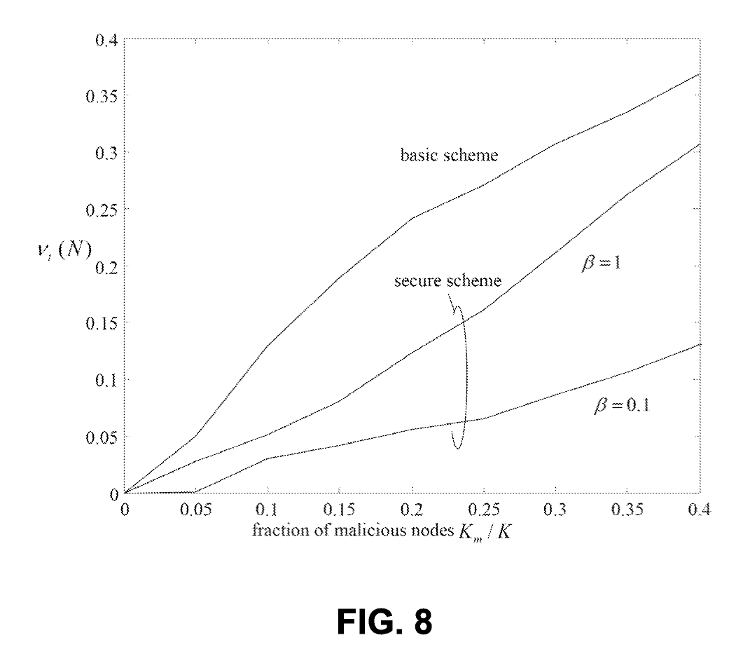

The following analysis demonstrates the benefits of the secure algorithm proposed above. FIG. 7 shows the standard deviation vₜ(n) of the secure scheme for different values of the system parameter β in (14). For small enough, the error vₜ(n) remains constant over n, thus showing that the secure scheme is able to achieve full synchronization within a limited (here 5%) timing error, as opposed to a more basic scheme. More insights are provided by FIG. 8, which shows the error vₜ(n) after n=100 iterations versus parameter β for different fraction of malicious nodes Kₘ/K over the total K=20. It can be seen that a sufficiently small β leads to a timing error that increases with Kₘ/K in a significantly less severe way than with respect to the basic scheme. Notice that results similar to FIG. 8 can be obtained for a different total number of nodes K.

### CONCLUSIONS

This patent application has described the use and implementation of pulse-coupled discrete-time PLLs for mutual time synchronization in wireless networks. Propagation delays and finite pulse resolution have been accounted for, and convergence analysis has been provided under simplified assumptions, showing that known results in the context of conventional PLLs for carrier acquisition extend naturally to distributed PLLs.

The following references were discussed above, and are incorporated herein in their entirety.

[1] F. Sivrikaya and B. F. Yener, “Time synchronization in sensor networks: a survey,” IEEE Network, vol. 18, no. 4, pp. 45-50, July-August 2004.

[2] Qun Li and D. Rus, “Global clock synchronization in sensor networks,” IEEE Trans. Computers, vol. 55, no. 2, pp. 214-226, February 2006.

[3] Y.-W. Hong, A. Scaglione, “A scalable synchronization protocol for large scale sensor networks and its applications,” IEEE Journal Selected Areas Commun., vol. 23, no. 5, pp. 1085-1099, May 2005.

[4] W. C. Lindsey, F. Ghazvinian, W. C. Hagmann and K. Desseouky, “Network synchronization,” Proc. of the IEEE, vol. 73, no. 10, pp. 1445-1467, October 1985.

[5] Wei Ren, R. W. Beard and E. M. Atkins, “A survey of consensus problems in multi-agent coordination,” in Proc. American Control Conference, vol. 3, pp. 1859-1864, June 2005.

[6] G. Scutari, S. Barbarossa and L. Pescosolido, “Optimal decentralized estimation through self-synchronizing networks in the presence of propagation delays,” in Proc. SPAWC 2006.

[7] F. M. Gardner, Phaselock Techniques, John Wiley & Sons, Inc., 1966.

[8] F. Tong and Y. Akaiwa, “Theoretical analysis of interbase-station synchronization systems,” IEEE Trans. Commun., vol. 46, no. 5, pp. 590-594, 1998.

[9] E. Sourour and M. Nakagawa, “Mutual decentralized synchronization for intervehicle communications.” IEEE Trans. Veh. Technol., vol. 48, no. 6, pp. 2015-2027, November 1999.

[10] O. Simeone and U. Spagnolini, “Distributed time synchronization in wireless sensor networks with coupled discrete-time oscillators,” submitted to Eurasip Journ. on Wireless Commun. and Networking (invited).

[11] R. E. Mirollo and S. H. Strogatz, “Synchronization of pulse-coupled biological oscillators” SIAM Journal on Applied Mathematics, vol. 50, no. 6, pp. 1645-1662, December 1990.

1. An apparatus comprising:
a virtual wireless network that is modeled using pulse-coupled discrete-time phase locked loops (PLLs), said virtual wireless network being based on a known point-to-point PLL system.

2. The apparatus of claim 1 that is configured to account for finite-time resolution of transmitted pulses.

3. The apparatus of claim 1 that is configured to account for finite-time resolution of propagation delays.

4. The apparatus of claim 1 that is configured to illustrate the impact of a finite resolution parameter.

5. The apparatus of claim 1 that is configured to illustrate the impact of a noise parameter.

6. The apparatus of claim 1 that is configured to illustrate the impact of an oversampling factor at the receiving side.

7. The apparatus of claim 1 wherein said loop order is arbitrary.

8. A method comprising:
modeling pulse-coupled discrete-time phase locked loops (PLLs) in a wireless network.

9. The method of claim 8 further comprising accounting for finite-time resolution of transmitted pulses.

10. The method of claim 8 further comprising accounting for finite-time resolution propagation delays.

11. The method of claim 8 further comprising illustrating the impact of a change to a finite-resolution parameter.

12. The method of claim 8 further comprising illustrating the impact of a change to noise parameter.

13. The method of claim 8 further comprising illustrating the impact of a change to an oversampling factor at the receiving side, said illustrating providing a basis for a selection of an oversampling factor that can maximize accuracy of synchronization in return for a reduction in complexity.

14. The method of claim 8 further comprising modeling the PLLs in a wireless network, said PLLs being in an arbitrary loop order.

15. A method for securing discrete-time distributed phase locked loops (PLLs) in a wireless network by including an outlier detection scheme in the timing update at each node, said method comprising:
evaluating each collaborating node based on a weighted average of the clock errors; and
evaluating the dispersion of clock errors.

16. The method of claim 15 further comprising considering as outliers all the clock differences that satisfy a predetermined formula.

17. The method of claim 16 further comprising updating the method of claim 16 for only the set of clock differences that satisfies a predetermined formula.

18. The method of claim 15 the evaluating each collaborating node comprising evaluating independent of direct estimation of the times of arrival of received pulses at each node.

19. The method of claim 15 the evaluating each collaborating node comprising leveraging a determination of an instantaneous energy measurement of a received signal via a center-of-mass detector.

20. A model of a pulse-coupled discrete-time phase locked loops (PLLs) in a wireless network, the PLLs at each node in the network having an indeterminate order.

21. The model of claim 20, wherein the number of poles at each node are indeterminate.

22. The model of claim 20 further comprising transmitting pulses in every period by switching between transmission and reception mode after pulse transmission.

23. The model of claim 20 further comprising allowing nodes to select independently whether to receive or transmit in order to improve the resolution of synchronization.
